(19) United States
(12) Patent Application Publication
(10) Pub. No.: US 2001/0047283 A1
(43) Pub. Date: Nov. 29, 2001

(54) ELECTRONIC SYSTEM FOR IDENTIFICATION, RECORDING, STORING, AND RETRIEVING MATERIAL HANDLING EQUIPMENT RECORDS AND CERTIFICATIONS

(76) Inventors: Bruce D. Melick, Cedar Rapids, IA (US); David M. Snyder, Cedar Rapids, IA (US); Leslie D. Baych, Cedar Rapids, IA (US)

Correspondence Address: ZARLEY MCKEE THOMTE VOORHEES & SEASE PLC, SUITE 3200, 801 GRAND AVENUE, DES MOINES, IA, 50309-2721, US

(21) Appl. No.: 09/774,831

(22) Filed: Jan. 31, 2001

Related U.S. Application Data
(60) Provisional application No. 60/179,495, filed on Feb. 1, 2000.

(51) Int. Cl. G06F 17/60

(52) U.S. Cl. 705/8

(57) ABSTRACT

A system and method for identification, recording, storing, and retrieving equipment records and certifications which includes a host computer linked to a remote computer which is linked to a scanner and printer. A database of information is stored on the host computer. A user accesses the database through a webpage viewed on a browser. The user may view or edit equipment information. The user may scan bar-coded information contained on an identification tag attached to the equipment. The identification tag is made of a durable material with an affixed printed tag and an over-laminate. The bar-coded information is displayed on the remote computer. Once the user has performed an inspection on the equipment, the user may update the information through a keyboard or other input device. This updated information is stored on the database. Using this database, reports can be generated to show compliance with governmental and insurance requirements.

### CROSS-REFERENCE TO RELATED APPLICATION

This application claims priority to U.S. provisional application Ser. No. 60/179,495 filed Feb. 1, 2000 entitled ELECTRONIC SYSTEM FOR RECORDING, STORING, AND RETRIEVING MATERIAL HANDLING EQUIPMENT RECORDS AND CERTIFICATIONS which is incorporated herein by reference.

### BACKGROUND OF THE INVENTION

1. Field of the Invention

The present invention relates generally to a method and system for identification, recording, storing, and retrieving equipment records and certifications. More specifically and in particular, the present invention relates to an electronic system and method for identification, recording, storing, and retrieving material handling equipment records and certifications stored on a third-party server while providing links, hyperlinks or references to applicable requirements and associated forms for recording data required by governmental agencies, industry safety departments, and insurance groups.

2. Problems in the Art

Currently, government regulatory bodies such as the Occupational Safety & Health Administration (OSHA), and standard settings organizations, such as the Canadian Standards Administration (CSA) and the American National Standards Institute (ANSI), promulgate regulations and establish standards intended to control the safety of the workplaces provided by employers to their employees. The Occupational Safety and Health Act of 1970 specifically authorizes information collection by employers as necessary or appropriate for the enforcement of the act or for developing information regarding the causes and prevention of occupational injuries, illnesses, and accidents. Most of these accidents and injuries, as well as the pain and loss of salary and productivity that often result, can be readily avoided.

One example of where these standards and regulations have been implemented is in the area of material handling equipment.

Whether during transit or at the work site, the ability to handle and move materials is vital to all segments of industry. Materials must be moved in order for industry to manufacture, sell, and utilize product. The mishandling of materials is the single largest cause of accidents and injuries in the workplace. Therefore, whenever possible, mechanical means should be used to move materials in order to avoid employee injuries such as muscle pulls, strains, and sprains. In addition, many loads are too heavy and/or bulky to be safely moved manually. Therefore, various types of equipment have been designed specifically to aid in movement and handling of materials. They include cranes, derricks, hoists, powered industrial trucks, conveyors, and personnel hoists used in a variety of industries such as construction, manufacturing, ship building, mining, etc.

Because all of these cranes, derricks, and hoists rely typically upon various types of slings to hold their suspended loads, slings are one of the most commonly used piece of materials-handling equipment. Slings are generally one of six types: chain, wire rope, metal mesh, natural fiber rope, synthetic fiber rope, or synthetic web.

A standard practice in the sling industry is to use sling identification tags manufactured from metal. As a sling is being assembled, a serial number and user information, which are both variable, are stamped onto the sling identification tag using a set of metal hand stamps and a hammer. This is a time consuming and expensive operation.

In general, use and inspection procedures tend to place the slings into three groups: chain, wire rope and mesh, and fiber rope and web. The majority of injuries and accidents caused by the misuse or mishandling of slings can be avoided by becoming familiar with the essentials of proper sling care and usage.

OSHA has promulgated many requirements and suggestions in this area. OSHA suggests that first, a user of a sling learn as much as possible about the materials with which that user will be working. Slings come in many different types, one of which is right for the purpose. Second, OSHA suggests that the user analyze the load to be lifted, in terms of size, weight, shape, temperature, and sensitivity, and then choose the sling which best meets those needs. Third, the user should always inspect all equipment before a lift. The equipment should be given whatever “in service” maintenance it may require. Fourth, the user should use safe lifting practices for the type of sling and the type of load.

Currently, OSHA requires employees to generate and maintain records regarding the inspection of slings. Employers are required to obtain and retain certificates showing that any new, repaired, or reconditioned alloy steel chain sling, wire rope sling with welded end attachments, and repaired synthetic web slings have been proof tested by the equipment manufacturer (or equivalent entity).

For example, OSHA regulation 1910.184, applies to slings used in conjunction with other material handling equipment for the movement of material by hoisting. This OSHA regulation requires the sling and all fastenings and attachments shall be inspected for damage or defects by a competent person designated by the employer. Additional inspections shall be performed during sling use where service conditions warrant. Damaged or defective slings shall be immediately removed from service.

In addition to the inspection required by the above OSHA standard, a thorough periodic inspection of slings in use should be made depending on the (A) frequency of sling use; (B) severity of service conditions; (C) nature of lifts being made; and (D) experience gained on the service life of slings used in similar circumstances. OSHA requires such inspections shall in no event be at intervals greater than once every 12 months. Employers are required to make and maintain a record of the most recent sling inspection.

OSHA, also requires that employers shall make and maintain a record of the most recent month in which each sling was thoroughly inspected, and that the employer shall make such record available for examination. In addition, safety departments and insurers of some large manufacturing companies, ship yards, etc. may require additional, and/or more frequent, inspections and associated records.

In various OSHA regulations there are also requirements for certifications. The certification specified in 29 CFR 1926.251(c)(15)(ii) is necessary to ensure compliance with the requirement for welded end attachments of the rigging equipment. They are intended to assure that welded end attachments of the rigging equipment are tested by the manufacturer at twice their rated capacity prior to initial use to avoid the possibility of occupational injuries and accidents.

The OSHA regulation 1926.552(c)(15) states: Following assembly and erection of hoists, and before being put in service, an inspection and test of all functions and safety devices shall be made under the supervision of a competent person. A similar inspection and test is required following major alternation of an existing installation. All hoists shall be inspected and tested at not more than 3-month intervals. The employer shall prepare a certification record which includes the date the inspection and test of all functions and safety devices was performed; the signature of the person who performed the inspection and test; and a serial number, or other identifier, for the hoist that was inspected and tested. The most recent certification record shall be maintained on file. This regulation also requires the employer certify and maintain records of the periodic and regular inspections of personnel hoists and the maintenance work performed.

The OSHA standard for Derricks, 29 CFR 1910.181, requires monthly inspections of ropes, and an inspection of ropes which have been idle for a period of a month or more, along with certification records of the inspections. Specifically, the employer is required to generate a certification record that verifies the equipment has been inspected in accordance with the requirements specified in the standard in order to maintain the derricks in a safe, reliable condition. Given the numerous requirements and suggestions, it is desirable for the employer to have an easy method of ensuring its compliance.

Historically, OSHA has targeted its compliance efforts towards entire industries. Industry data are extremely useful to OSHA for identifying categories of problems (e.g., specific industries and occupations at risk, etc.). However, targeting interventions towards entire industries is not the most efficient use of the Agency's resources. Aggregation of data by industry masks the experience of individual employers. In almost every industry, a small percentage of the establishments experience disproportionately large numbers and/or high rates of injuries and illness. Data from relatively safe workplaces in high rate industries are lumped in with data from unsafe workplaces; and unsafe workplaces in relatively low rate industries avoid OSHA scrutiny altogether. Furthermore, studies have shown that the injury and illness experience for these establishments generally persists over time (particularly the larger ones). Establishments with high injury and illness rates tend to continue to have high rates. One purpose of the OSHA data initiative is to give OSHA the capability of focusing on those establishments with serious safety and health problems.

American business is composed of more than 6,500,000 workplaces. Federal OSHA and its State partners perform approximately 110,000 on-site visits per year. Since Federal OSHA and its State partners can only visit a small portion of America's workplaces, government resources could be used more effectively if OSHA interacts with employers in a new way.

In recent years, OSHA has taken initiatives to enhance safety, trim paperwork, and transform OSHA. These changes were instituted to ensure “an America whose workplaces, as far as possible, are free from hazards that are causing or likely to cause death or physical harm.” The annual collection of employer specific injury and illness data improves OSHA's ability to identify and target agency interventions to those employers who have serious workplace problems. Through the continued implementation of it's annual Data Initiative, OSHA is able to leverage its resources. The result is a reduction in OSHA interventions in workplaces that are relatively safe and healthy, and the more effective use of OSHA's limited resources in more hazardous workplaces, the goal being improved workplace safety and health for America's workers.

Another purpose of the OSHA Data Initiative is to allow OSHA to comply with the Government Performance and Results Act (GPRA). Historically, the Agency has relied on activity measures, such as a number of inspections, to evaluate itself and the State plan programs and has had no mechanism for evaluating the Agency's impact on reducing workplace injuries and illnesses in individual workplaces. Annual collection of employer specific injury and illness data will allow the agency to monitor the results of its activities, evaluate its various programs based on program results, identify the most efficient and effective program mix, and promote the development of programs and policies based on outcome data.

Sections 8 and 24 of the Occupational Safety and Health Act, 29 U.S.C. 657, 673 and reporting regulations at 29 CFR 1904.17, authorize OSHA to collect the requested information by mail. Non-respondents may be cited and issued penalties for non-response to the collection request itself. Also, establishments that fail to return a completed form may be scheduled for an on-site records inspection or issuance of an administrative subpoena for the information. It is therefore desirable to have a method and system capable of generating the OSHA requested information.

The collections of information will be used to determine if employers are in compliance with the OSHA standard. OSHA allows employers to use information technology, e.g., permitting electronic submission of responses, whenever appropriate for reporting or maintaining records associated with the standard. In addition, the collections of information may be used to determine compliance by industry safety departments and insurer's.

Currently, there are numerous problems in the workplace with material-handling equipment records and reporting. The development of workplace material-handling equipment inspections and reporting methods are often haphazard and non-structured. To ensure compliance with the applicable governmental regulations, industry safety departments and insurer's standards usually requires the accumulation and maintenance of many forms. These forms may include, for example, sling inspections, material certifications, proof test certificates, traceability codes, etc. Further, once any workplace material-handling equipment program has been developed, this program must be maintained in order to assure continuing compliance with the applicable governmental, industry safety departments, and insurer's regulations and standards.

Moreover, responsibility within the workplace for the development and maintenance of workplace material-handling equipment programs may be delegated to many people, may be decentralized, and may not be clearly defined. The forms created during both the development and the maintenance of the workplace material-handling equipment program typically are filled out by many people and are stored in a great many locations within a workplace, which can make finding these records difficult.

Workplaces are also frequently audited to assure that the employer is in compliance with the applicable governmental, industry safety departments, and insurer's regulations and standards. Because the forms and records used in the workplace material-handling equipment program are typically decentralized and may be scattered throughout a workplace, it may be extremely difficult for the employer to prepare for an audit. Failure to assure the auditor that the employer is in compliance with the governmental, industry safety departments, and insurer's regulations and standards can lead to the imposition of fines and other penalties.

While some efforts have been made in the past to create software to manage compliance in the workplace with various governmental, industry safety departments, and insurer's regulations and standards relating to material-handling equipment, such efforts have not been uniform and comprehensive.

Such software programs, however, do not permit links, hyperlinks, or references to the requirements and forms of a workplace material-handling equipment program, do not integrate the customization of workplace material-handling equipment requirements and the display of forms useful in the customization process, do not integrate the development of a material-handling equipment program which complies with governmental, industry safety departments, and insurer's standards and regulations, and the assistance necessary for the preparation of an audit.

There is therefore a need for a uniform and comprehensive method and system to identify material handling equipment, electronically record, store, and retrieve inspection, test records, and certifications related to said equipment for OSHA, industry safety departments, and insurer's requirements, in a centralized location.

### FEATURES OF THE INVENTION

A general feature of the present invention is the provision of a method and system which overcomes the problems found in the prior art.

Another feature of the present invention is the provision of a system and method for the identification of equipment, and the reporting, storage, and retrieval of inspections and certifications relating to that equipment, which is easy to use.

Another feature of the present invention is the provision of a system and method for storing inspections, certifications, and equipment data in a centralized location.

A further feature of the present invention is the provision of subscriber access and control of their data stored on a network server.

A still further feature of the present invention is to provide a subscriber with the ability to change their data stored on a network server.

Another feature of the present invention is to provide a subscriber with the ability to report their data to be stored on a network server.

A further feature of the present invention is the provision of bar-coded tags to identify material-handling equipment.

A still further feature of the present invention is to provide a subscriber the ability to make their own and use existing links to specifications, drawings, work instructions, or web pages that can be stored on the Internet, a Wide Area Network (WAN), or Local Area Network (LAN).

Another further feature of the present invention is to provide a subscriber data and/or forms to complete the inspections required by government agencies, industry safety departments, insurers, and others.

A further feature of the present invention is to provide a subscriber data and/or forms necessary to create new records required by government agencies, industry safety departments, insurers, and others.

A still further feature of the present invention is to provide a subscriber data and/or forms to record repairs and re-certifications required by government agencies, industry safety departments, insurers, and others.

A further feature of the present invention is the provision of a method of identifying specific equipment by the use of bar-codes and related bar-code scanning equipment.

Another feature of the present invention is the provision of using a database to drive the printing of printed tags for identification purposes.

These, as well as other features and advantages of the present invention, will become apparent from the following specification and claims.

### SUMMARY OF THE INVENTION

The present invention relates to the identification of equipment, the recording, storage, and retrieval of electronic records relating to said equipment. More specifically and in particular, the present invention relates to a uniform and comprehensive electronic system and method for identification, recording, storing, and retrieving material handling equipment records and certifications at a centralized location. The present invention provides links to applicable requirements and associated forms for recording data required by governmental agencies, industry safety departments, and insurers.

The present invention provides a method for the identification of material handling equipment, the recording, storage, and retrieving data related to required inspections and certifications of that equipment. This equipment can be, but is not limited to, cranes, derricks, hoists, powered industrial trucks, conveyors, personnel hoists, and slings of one of six general types: chain, wire rope, metal mesh, natural fiber rope, synthetic fiber rope, or synthetic web.

Third party data storage is provided on a network server or “host”. This data will be accessible via the Internet by a subscriber from the subscriber's computer or “remote”. Forms for data recording, storing, and retrieving will be on the network server for the subscriber to use. These forms will support three basic activities: inspection, creation of new records, and logging of repairs made and/or the re-certification of various types of material-handling equipment.

These forms reflect the basic government, industry safety departments, and insurer's requirements for inspection, certification, and associated record keeping. The data recorded can be customized to the users requirements but the forms cannot be changed except by the third party. The forms may include customer specific data such as information relating to an inspector's qualifications, etc. These forms also will be able to be linked, with hyperlinks, to specifications, drawings, work instructions, or web pages that reside on the Internet, a Wide Area Network (WAN), or Local Area Network (LAN), further broadening the integration of information available to the subscriber.

### BRIEF DESCRIPTION OF THE DRAWINGS

FIG. 1 is a flowchart representation of the preferred method of the present invention.

FIG. 2 is a pictorial representation of the system of the present invention.

FIG. 3 is a pictorial representation of one embodiment of an identification tag used on a sling in accordance with the present invention.

FIG. 4 is a pictorial representation of the main menu screen as seen by a user of the present invention.

FIG. 5 is a pictorial representation of the system function selection screen of the present invention.

FIG. 6 is a pictorial representation of the sling input screen of the present invention.

FIG. 7 is a pictorial representation of the sling records screen of the present invention.

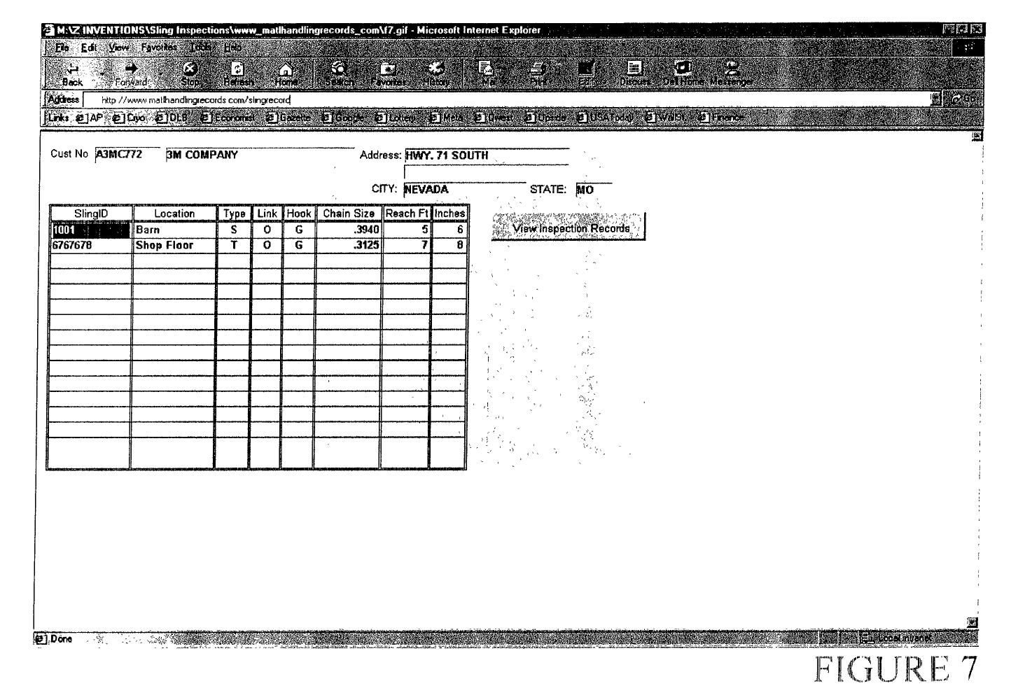

FIG. 8 is a pictorial representation of the inspection record form of the present invention.

FIG. 9 is a pictorial representation of the record editing screen of the present invention.

FIG. 10 is a pictorial representation of the branches list screen of present invention.

FIG. 11 is a pictorial representation of the customer list screen of the present invention.

FIG. 12 is a pictorial representation of the damage code screen of the present invention.

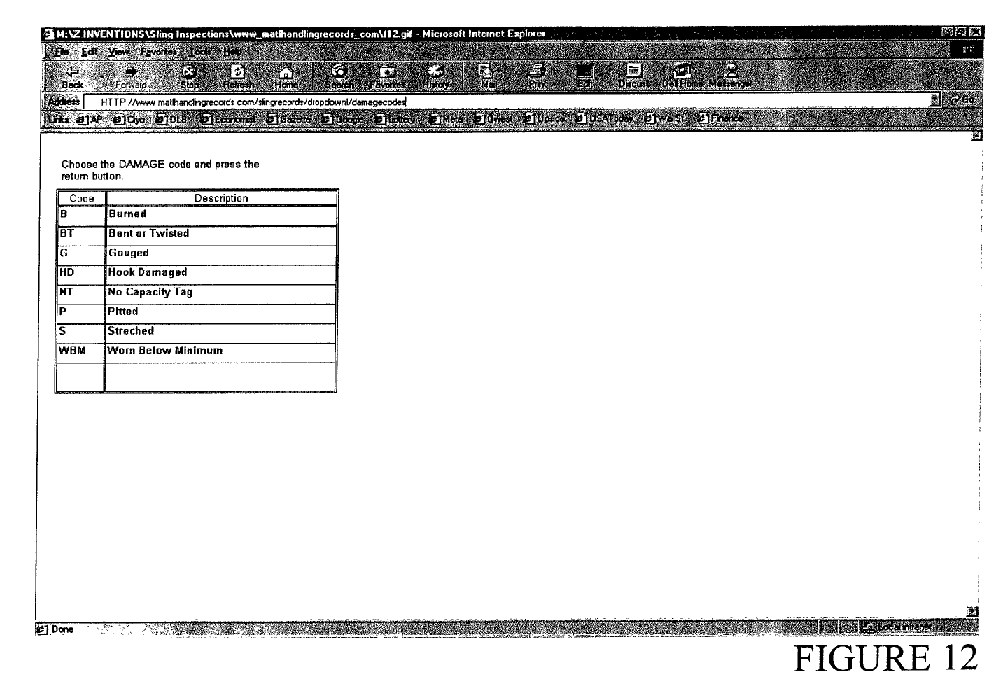

FIG. 13 is a pictorial representation of the chain grade screen of the present invention.

FIG. 14 is a pictorial representation of the hook type screen of the present invention.

FIG. 15 is a pictorial representation of the inspector list screen of the present invention.

FIG. 16 is a pictorial representation of the link type screen of the present invention.

FIG. 17 is a pictorial representation of the manufacturer list screen of the present invention.

FIG. 18 is a pictorial representation of the other information screen of the present invention.

FIG. 19 is a pictorial representation of the link size screen of the present invention.

FIG. 20 is a pictorial representation of the sling type screen of the present invention.

### DETAILED DESCRIPTION OF THE INVENTION

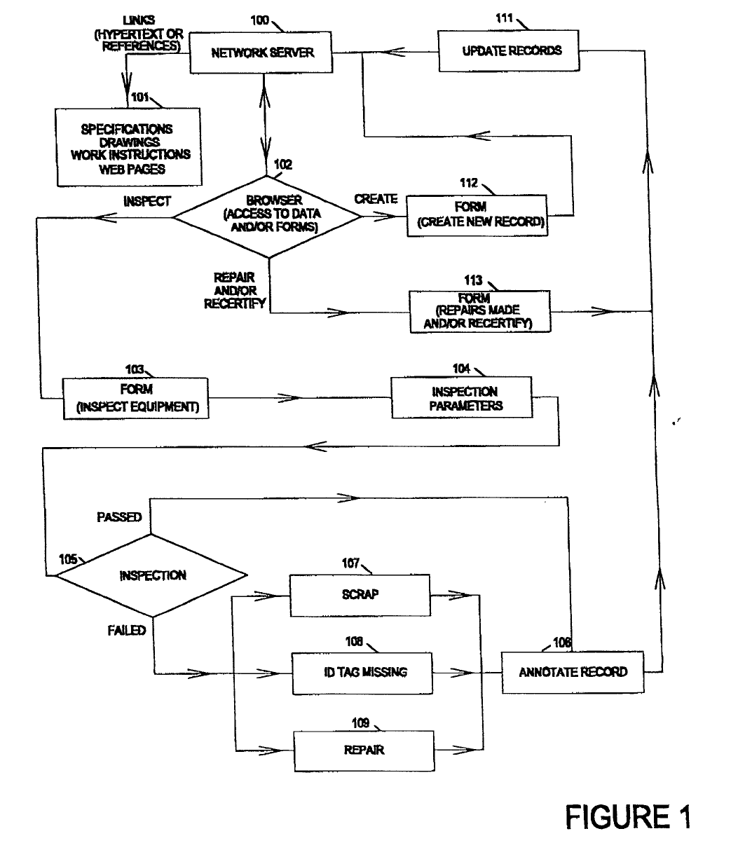

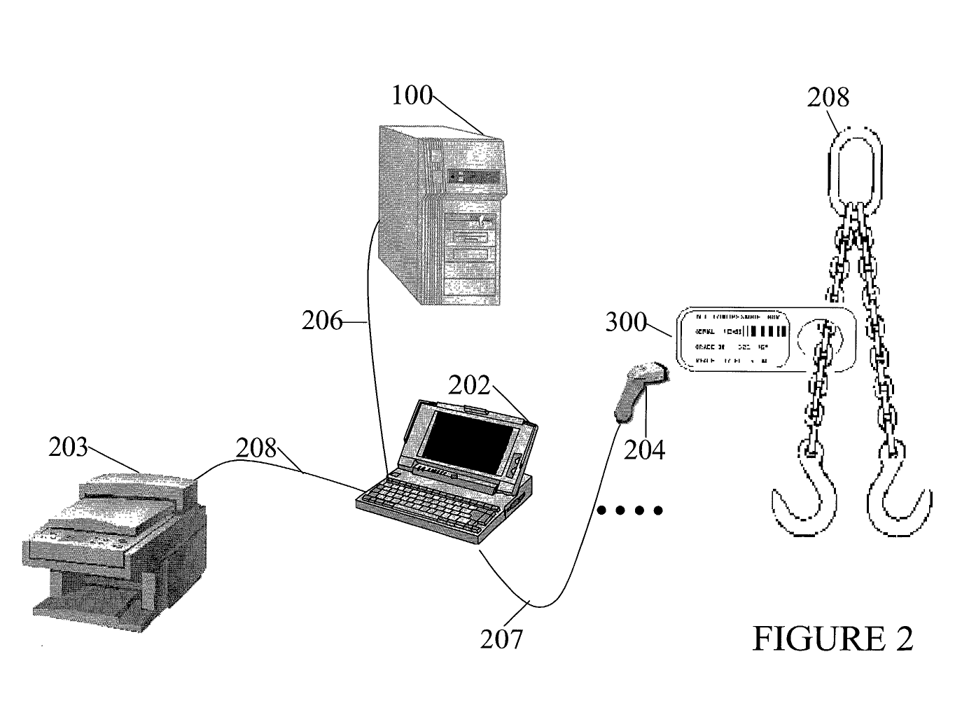

The present invention generally comprises a method and system for identification, recording, storing, and retrieving equipment records and certifications. In a preferred embodiment, the present invention includes a hardware system, shown in FIG. 2, which is preferably used in performing the method of the present invention as shown in FIG. 1.

Even though the present invention relates to material-handling equipment, such as, cranes, derricks, hoists, powered industrial trucks, conveyors, personnel hoists, and slings of one of six general types: chain, wire rope, metal mesh, natural fiber rope, synthetic fiber rope, or synthetic web, for the purpose of clarity the detailed description as follows represents the use of the system as it relates to an alloy chain sling.

Initially, a user of the present invention accesses a third party network server 100 to which the user is a subscriber. Access is obtained through a browser 102 which displays a webpage, not shown, on the subscriber's remote computer 202 Both computers 100 and 202 are Internet capable, meaning they can connect to the Internet using Transfer Control Protocol (TCP/IP) and an internet service provider. On the webpage, a subscriber is requested to enter an access code and user identification so as to access and view their records and other information. Each subscriber would have their own individual access code and user identification which would allow each subscriber to independently provide, edit, review, and download equipment records and information. Should any questions arise, subscribers would be able to click on the e-mail address provided to ask the provider of services any desired questions. The webpage and the forms associated therewith are created using web development software using hypertext markup language or JavaScript, etc., such as, but not limited to, Microsoft FrontPage, and database software, such as, but not limited, Corel Paradox or Microsoft SQL. The programming code attached to this patent application as Appendix A was developed with an Object Oriented application development tool in a client/server environment. The code enclosed does not contain all code on all objects displayed in the figures. The containership structure of object oriented development prohibits the inclusion of all code contained within each form. The forms associated with the webpage allow the subscriber to create new records, inspect and repair and/or re-certify a desired piece of equipment, such as a specific alloy chain sling.

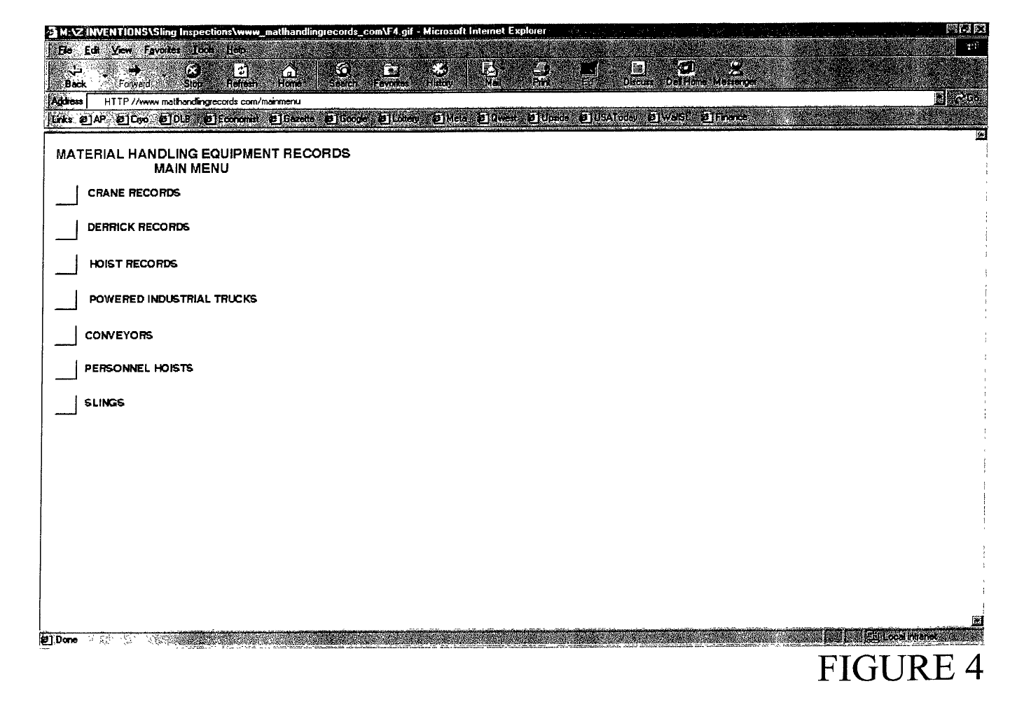

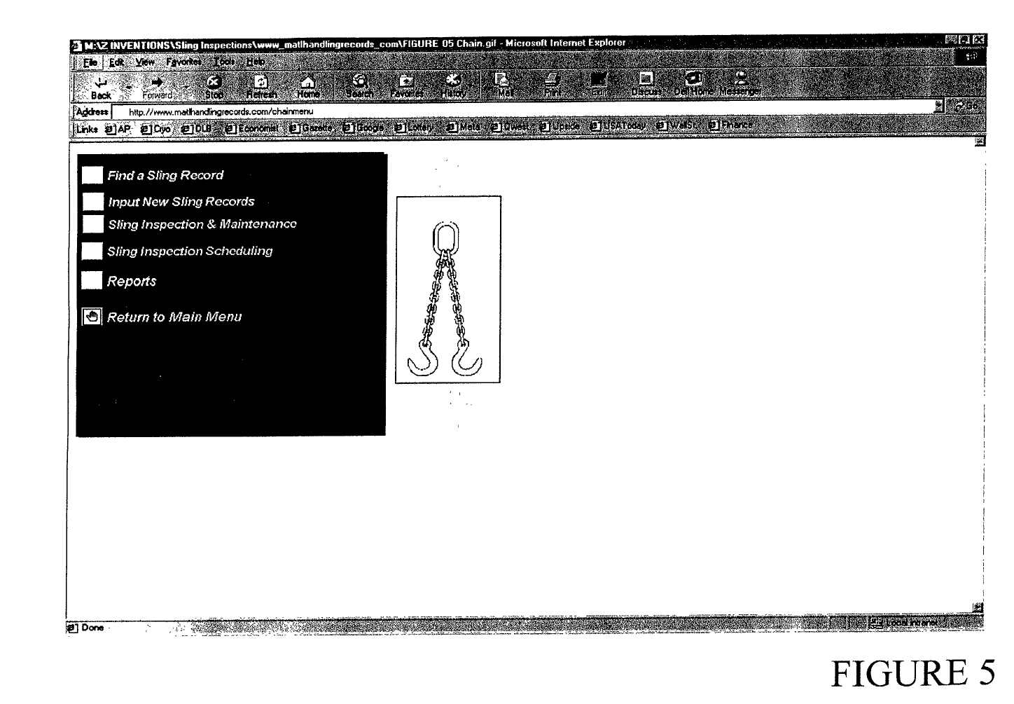

From the main menu, as shown in FIG. 4, the subscriber may select a type of records with which they would like to deal. For instance, if the subscriber clicks on the slings button shown in FIG. 4, the subscriber will be redirected towards a sub-menu allowing them to select the type of system function with which they want to work. This sub-menu is shown in FIG. 5. The sub-menu of FIG. 5 controls the access to various forms and allows the subscriber to input new sling records, find information contained in a sling record, report new maintenance and inspection information, schedule sling inspections, and compile reports.

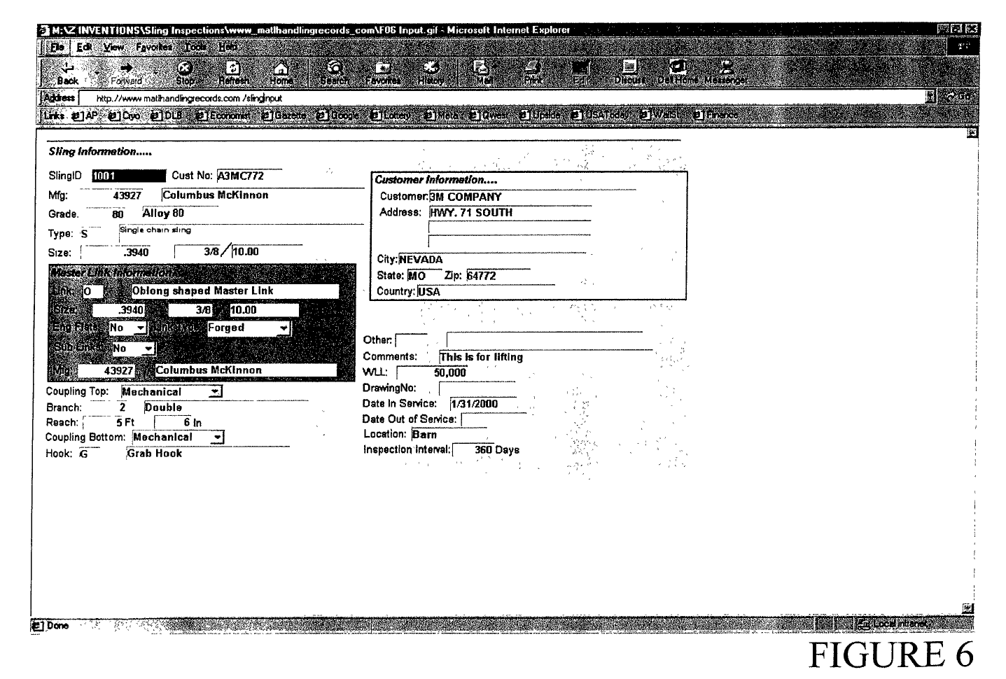

If the subscriber wishes to create a new sling record, the subscriber will be directed to an input form 112 as shown in FIG. 6 (shown with sample data). This form 112 allows the user to input all detailed record information associated with the new sling. This information includes a unique identifier code, customer specific information, detailed configuration and component information.

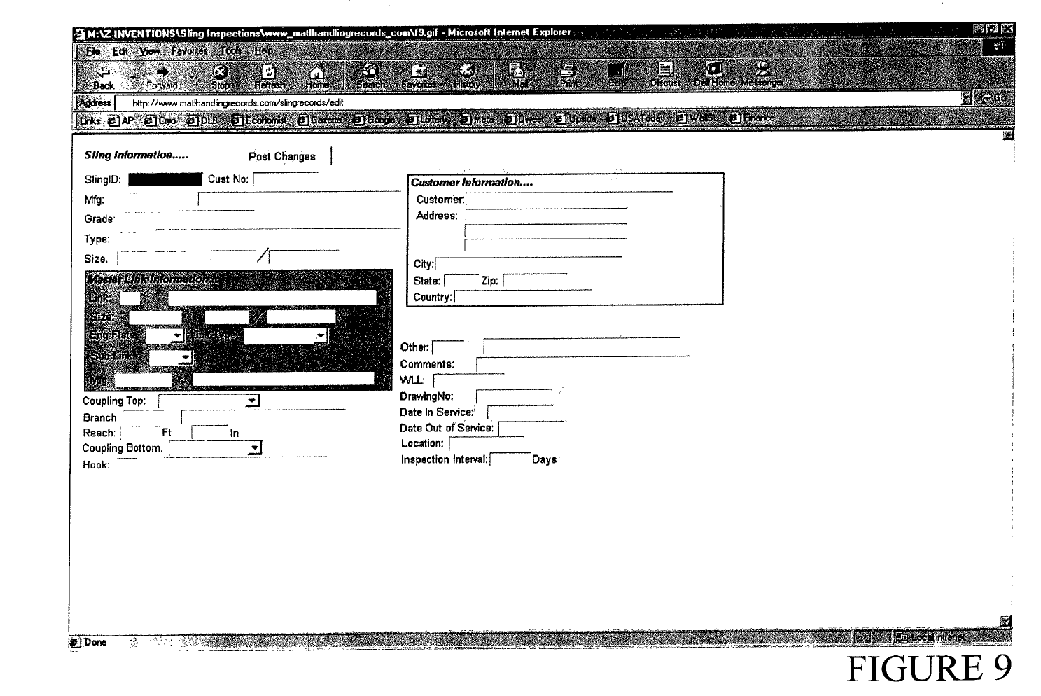

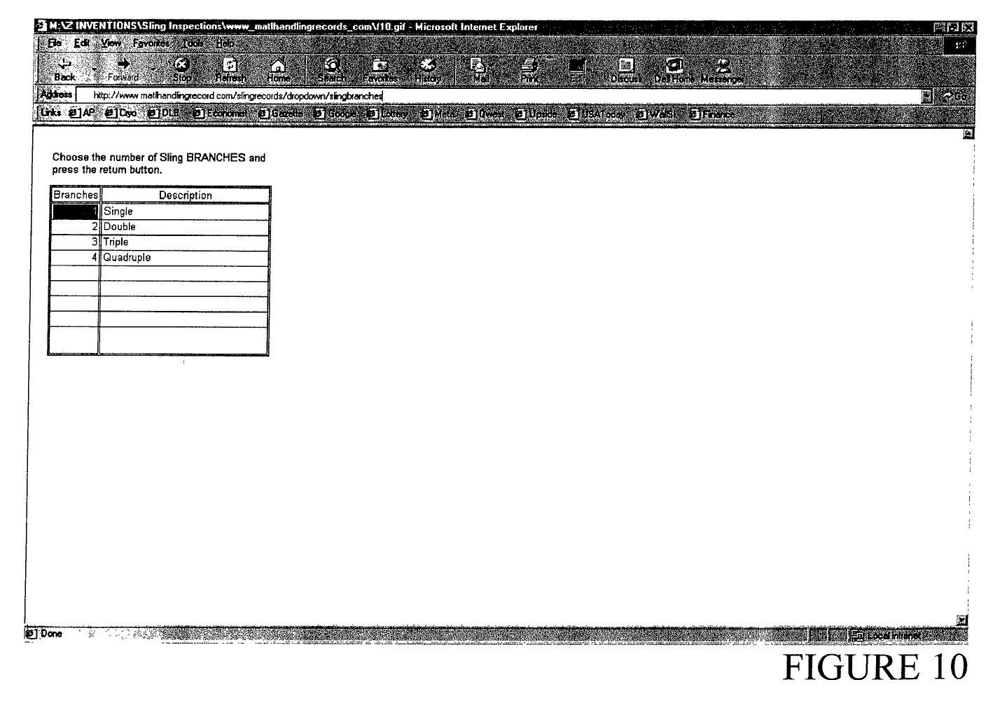

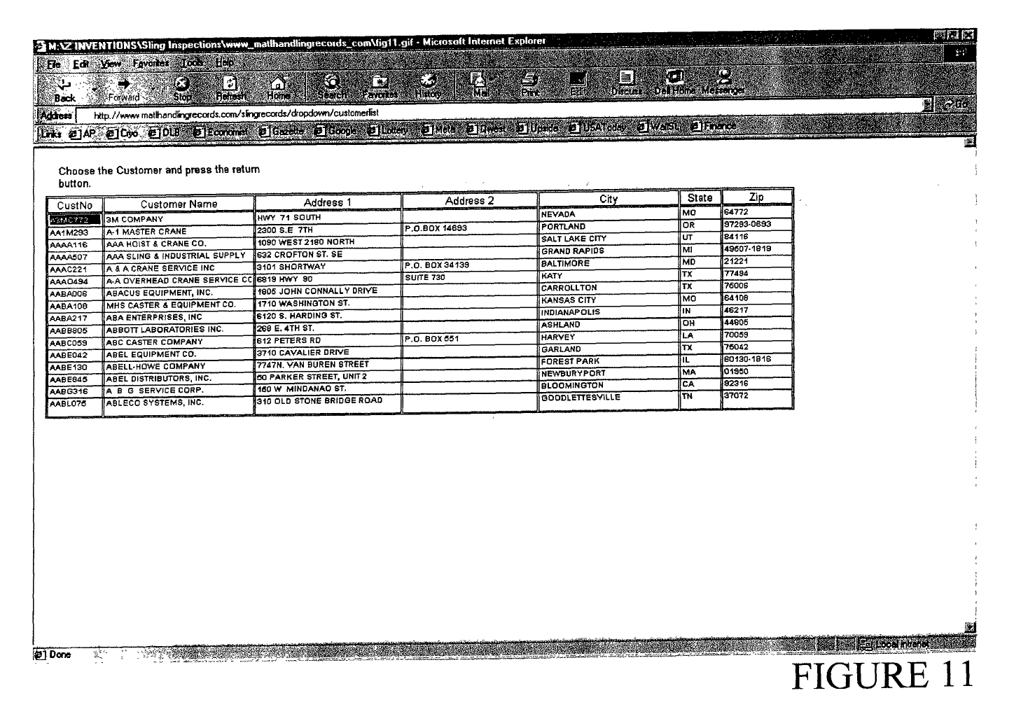

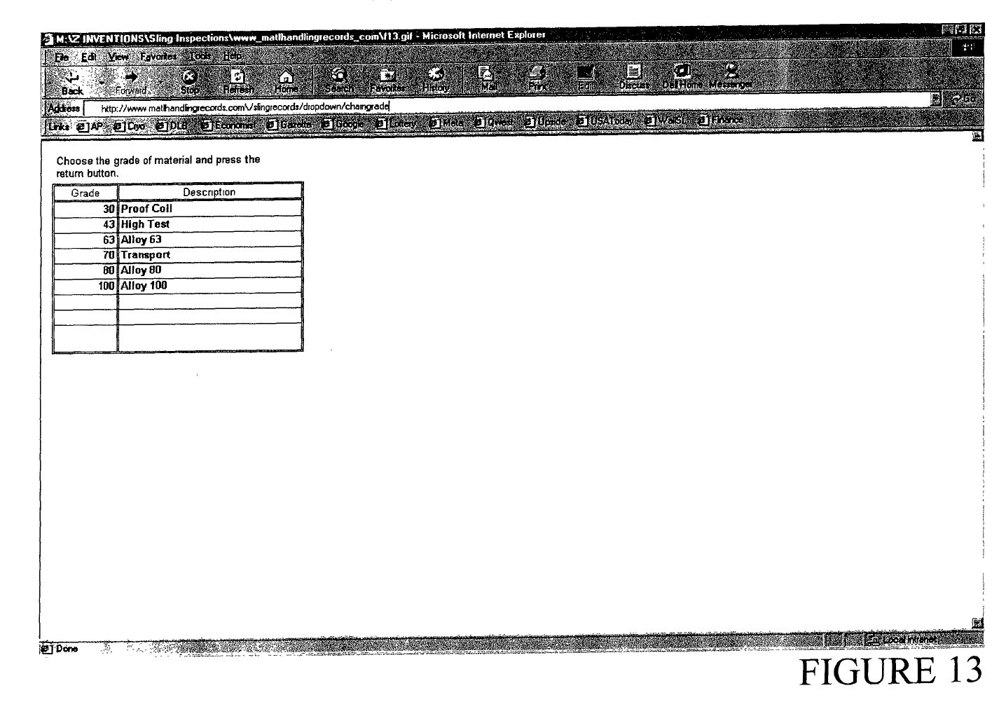

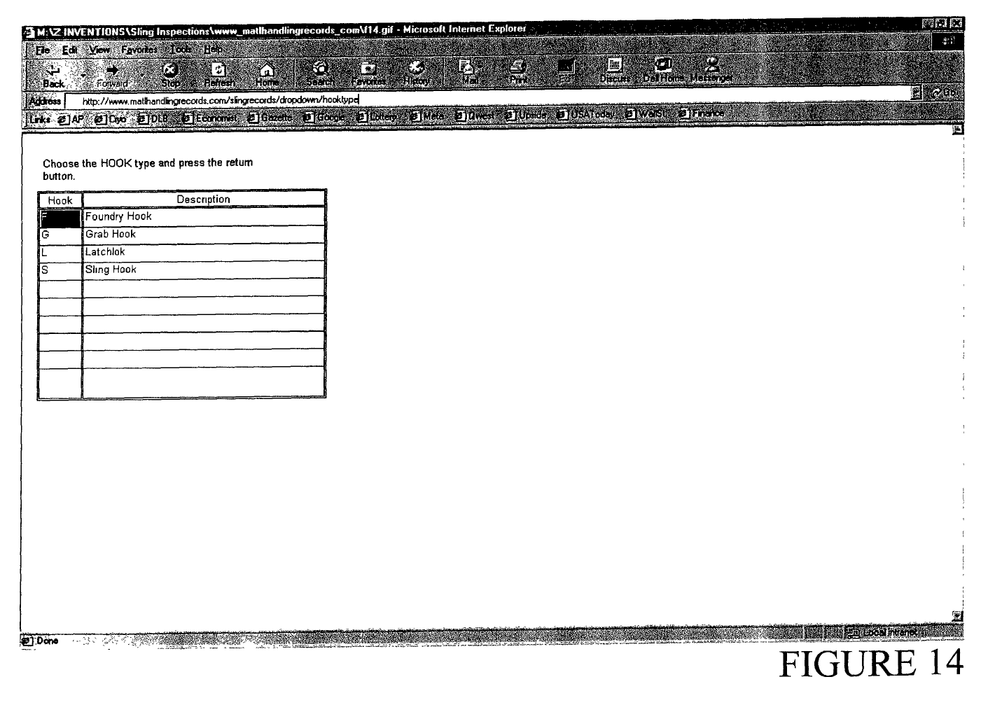

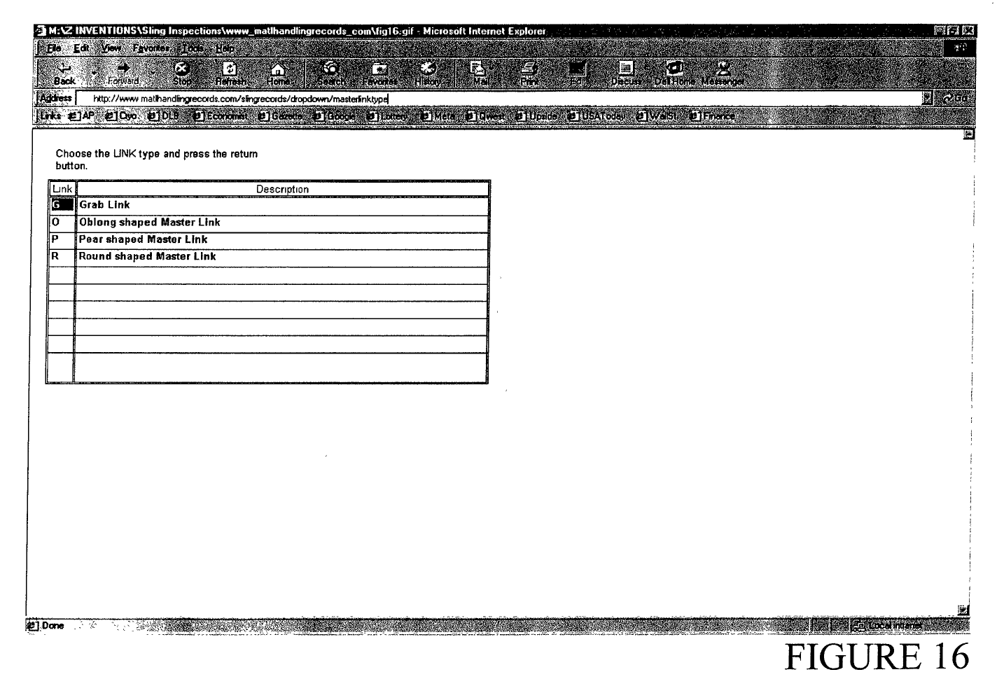

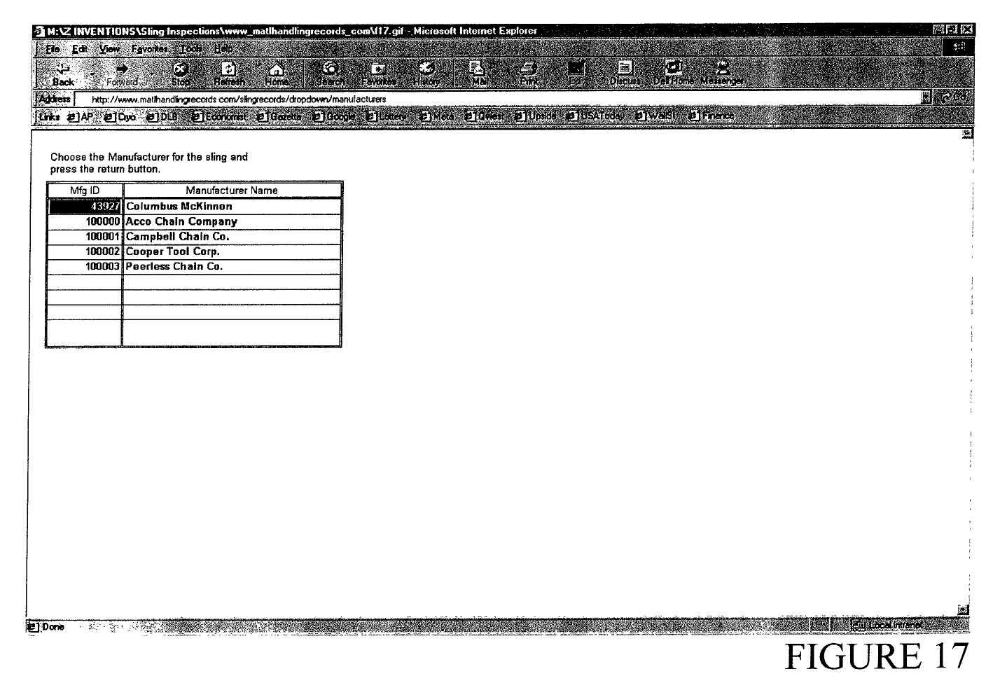

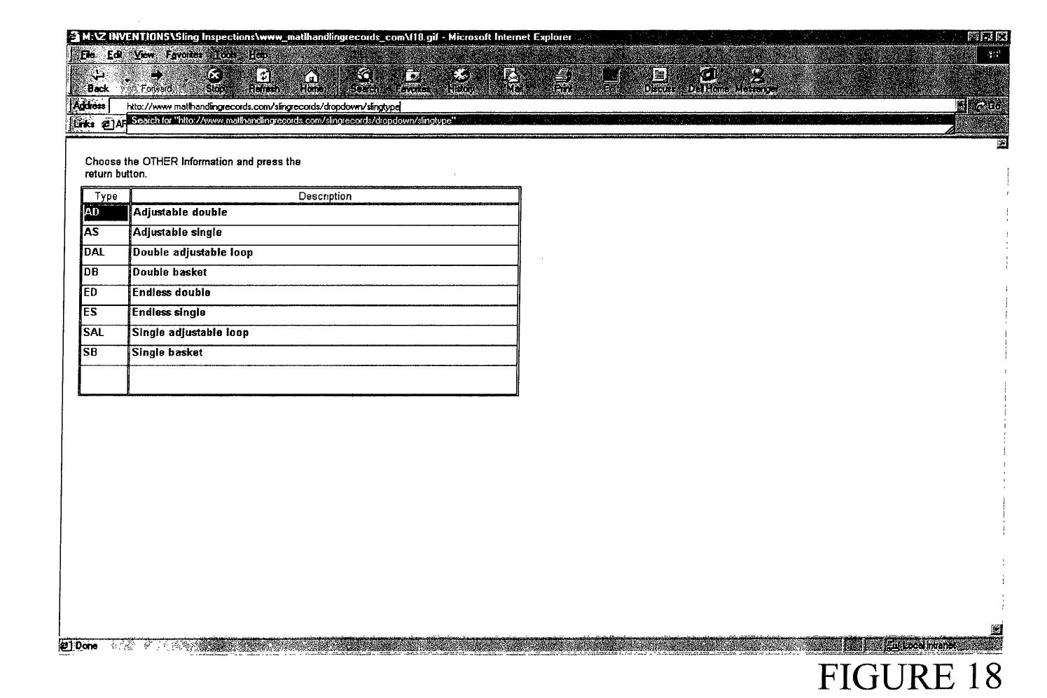

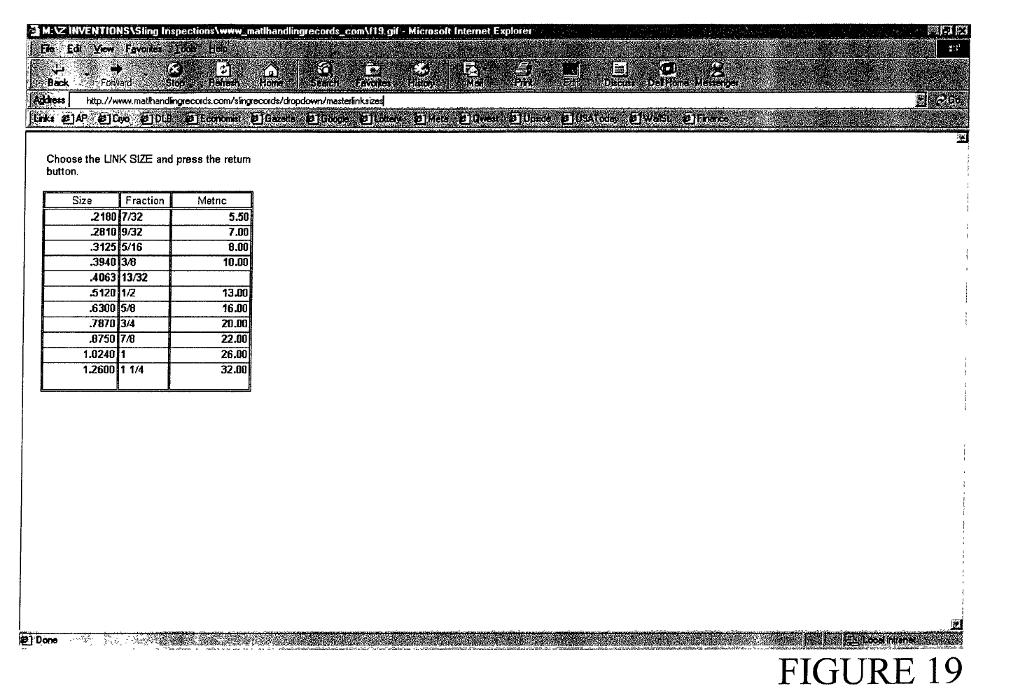

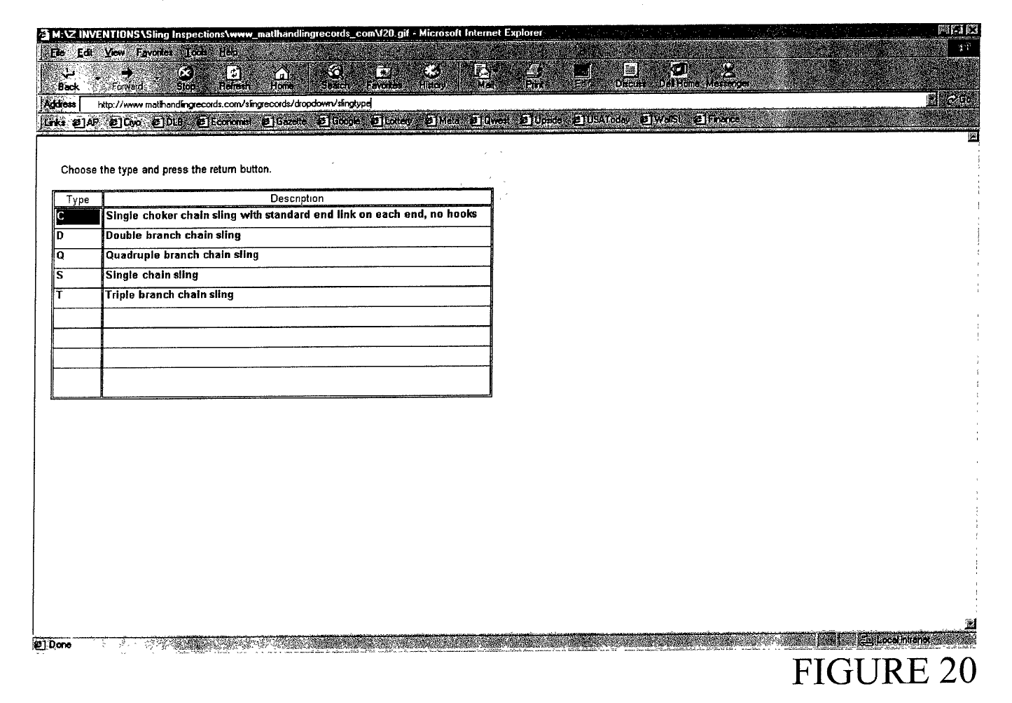

Alternatively, the subscriber may choose to edit an existing record and is directed towards and edit form 113 as shown in FIG. 9. The edit form 113 is identical to the input form 112 except that the subscriber does not have the ability to edit the sling identification and thereby add a new record. All other fields may be modified. Both the input form 112 and the edit form 113 allow a subscriber to use table driven listing information which is linked to each record. For example, the subscriber may select from a list of branch types by double clicking on the word “Branch” which will direct them towards a branch selection screen as shown in FIG. 10. Similarly, the subscriber may select from the customer list as shown in FIG. 11. Also, the subscriber may select the grade type from the list, as shown in FIG. 13, the hook type from the list as shown in FIG. 14, the link type from the list as shown in FIG. 16, the manufacturer, from the list as shown in FIG. 17, the size of the sling from the list of standard sizes as shown in FIG. 19 and the general sling type from the list as shown in FIG. 20. Additionally, other information which is commonly desired may be presented in another table as shown in FIG. 18. All of these are table driven listings linked appropriately to a corresponding location in the input form 112 and the edit form 113. The new records from input form 112 are then stored on the network server 100. The updated information contained in the edit form 113 is then used to update the records 111. The updated records 111 are then stored on the network server 100.

Preferably, a new or existing serial number for the desired alloy chain sling is input via a bar-code, radio frequency identification (RFID) tag, or manually. Pertinent information relating to the selected chain sling, such as the working load limit (WLL), reach, size, grade, and other information, is then input into either the input form 112 or the edit form 113. This data is now ready for use by the subscriber for use in printing identification tags, subsequent inspections, or reports. Further, information on repairs, items replaced, trace codes, and proof test results may also be input into the edit form 113.

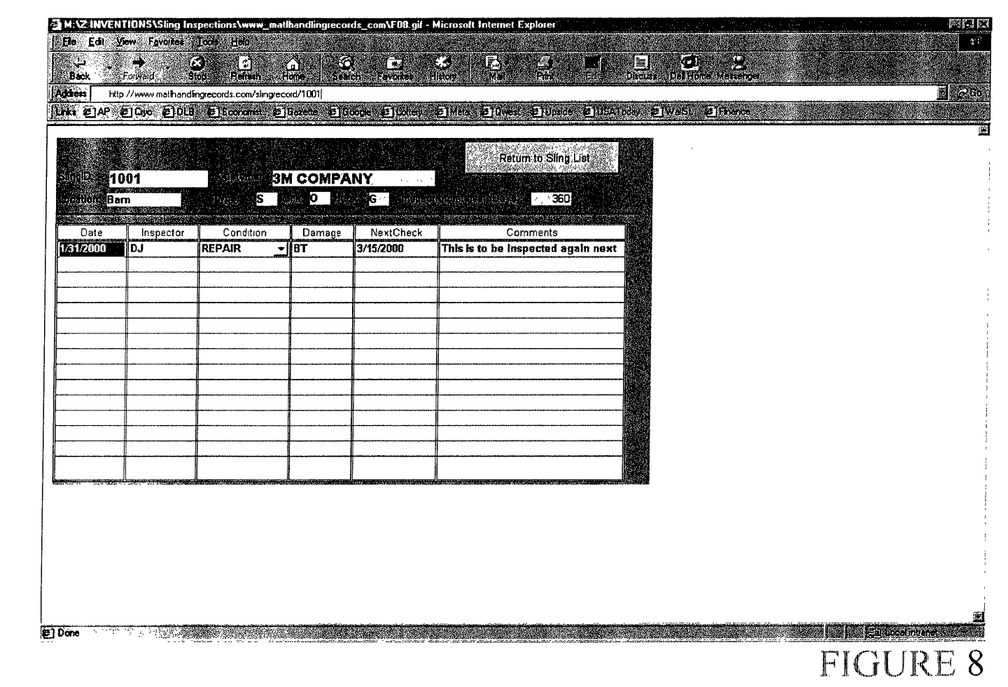

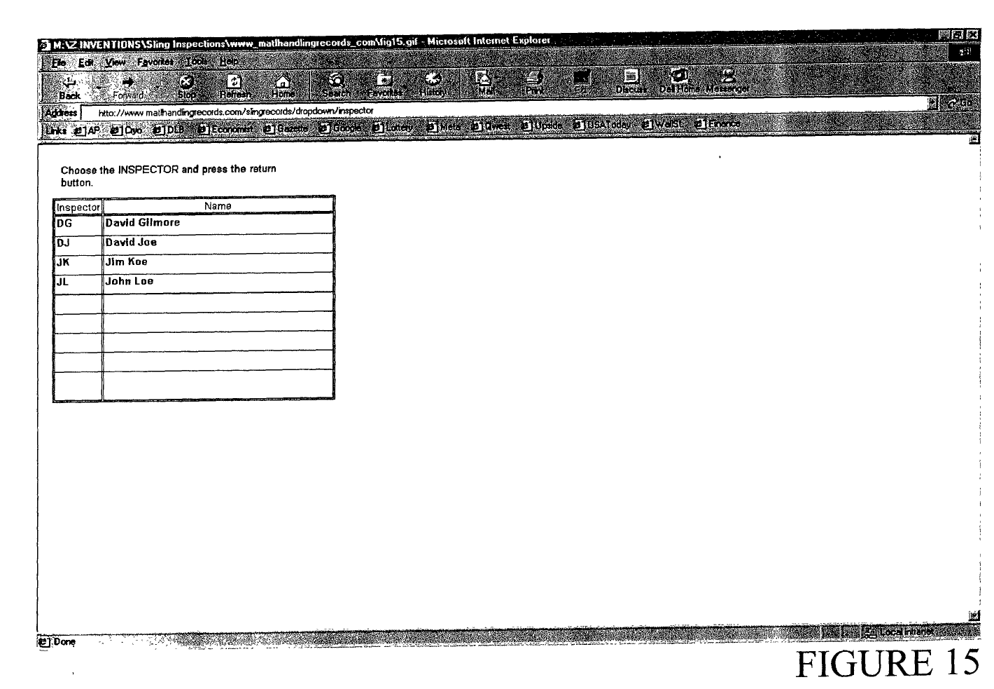

When the subscriber selects the sling inspection and maintenance button, shown in FIG. 5, the subscriber is directed to the inspection form 103, shown in FIG. 8. The inspection form 103 requires that the subscriber input the serial number of the selected sling either manually or via a bar-code or RFID tag. Upon entry of the serial number, the subscriber is presented with the inspection parameters 104 such as, the working load limit, reach, size, grade, etc. which are stored on the network server 100 with the appropriate record for that sling. If the sling has been inspected before, the subscriber will also be presented with the individual slings inspection history and disposition. Further, the subscriber will be presented with information on the next check date, which allows for future scheduling and reminders of when upcoming periodic inspections will be due. After reviewing the pertinent information, the subscriber may perform the inspection 105. Prior to performing the inspection, the subscriber should indicate that they are the inspector. They may indicate that they are the inspector by selecting their name or initials from the list of inspectors as shown in FIG. 15. Again, this list of inspectors is a table driven listing linked to the appropriate location in the sling inspection record.

After performing the inspection, the subscriber may note whether the particular piece of equipment has passed or failed. If the inspection results in a failure, the subscriber may indicate what should be done with the piece of equipment. For example, a subscriber may choose that the sling be scrapped and select a scrap icon 107, note that the identification tag is missing and select the ID tag missing icon 108, or suggest that the sling be repaired and select the repair icon 109. The outcome of the inspection is then recorded and a record annotation 106 is prepared. This record annotation 106 is used to update the record 111 which is then stored on the network server 100.

The preferred system of the present invention is shown in FIG. 2. As shown, the system is comprised of a third-party's network server 100. The server 100 may reside on the Internet, or optionally on a wide-area network (WAN), or local area network (LAN). The server 100 has all of the necessary hardware and software required to store a subscriber's data, as well as control the access to the subscriber's data from any computer equipped with an Internet browser 102.

Operatively connected to the network server 100 is a subscriber's computer 202. The subscriber's computer 202, or remote computer, may be a desktop personal computer, a pen-based personal computer, a personal digital assistant (PDA), or a simple terminal. The link 206 between the third-party network server 100 and the subscriber's computer 202 may be a hardwire linkage or a wireless linkage as are commonly known in the art. The link 206 will ensure that data flows in both directions between the subscriber's computer 202 and the network server 100.

Preferably the subscriber's computer 202 is equipped with a keyboard which is normally used to manually input instructions and information. The subscriber's computer 202 may also be equipped with an optional bar-code scanner 204. This bar-code scanner 204 can be used to capture bar-coded data into an active software program on the subscriber's computer 202. Many handheld bar-code scanners 204 which are capable of reading a printed bar-code are available commercially today. The bar-code scanner 204 may be a handheld or even pen-based unit. The bar-code scanner 204 is linked to the subscriber's computer 202 through a hardwired or wireless link 207. The data on link 207 goes only in one direction, from the bar-code scanner 204 to the subscriber's computer 202.

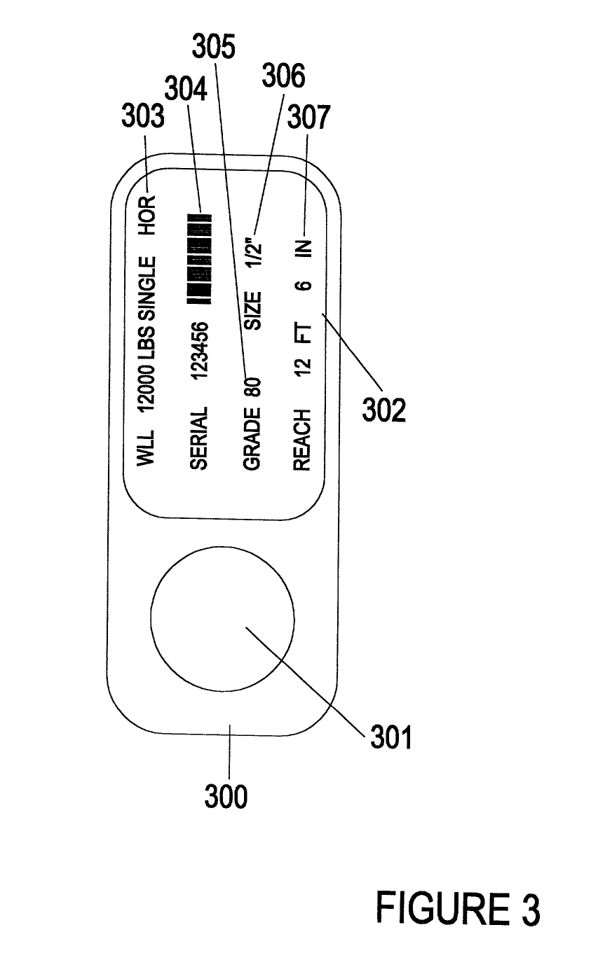

The bar-code scanner 204 is used to read a bar-code 304 on an identification tag, such as the sling identification tag 300, shown in greater detail in FIG. 3. The bar-code 304, shown in FIG. 3, represents an identification number. The identification may be numeric, alpha or alpha-numeric. The bar-code 304 may exist in any number of standard one-dimensional machine readable formats, such as, but not limited to, Code 39, Code 128, Interleaved 2 of 5, UPC-A, UPC-B, etc. The bar-code 304 is shown in FIG. 3 as a linear bar-code, but may be a standard two-dimensional bar code, such as PDF-417 which contains more information than the identification number of the material handling equipment. These one and two dimesional bar-codes may also be proprietary. The bar-code 304 will allow an inspector, or subscriber to interface with the present invention's database and bring up a material handling equipment record without typing the serial number into any input field.

The sling identification tag 300, shown in FIG. 3 is made of a durable material such as metal or plastic. A hole 301 is put in the sling tag such that one of the legs of the sling 208, shown in FIG. 2, may pass through the hole 301 to permanently affix the sling identification tag 300 to a sling 208. Of course, the hole 301 may be of any desirable dimension.

While information may be printed directly on the sling identification tag 300, it is preferred that a printed tag 302 be affixed, by glue or other means, to the sling identification tag 300. Printed tag 302 is preferably made from a durable material and may optionally have what is referred to as an “over laminate”, which is a tough, clear laminate that provides an optional measure of durability to printed tag 302.

The printed tag 302 may be customized as to color and could include a spot for the printing of a sling manufacturer's logo and contact information. The printed tag 302 is printed from an ordinary printer and may contain any desirable information. For example, the printed tag, shown in FIG. 3, contains the working load limited (WLL) of the alloy chain sling to which sling identification tag 300 is attached. The “WLL” and “HOR” markings are static information. The “12,000 pounds single” markings are variable. In this example, they are related specifically to the grade and size of the alloy chain being used to make up the sling. The present inventions database will contain the working load limit 303 information and can drive the printing of this tag information in a printing process. Additionally, the printed tag 302 will contain the serial number of the sling 208. The “SERIAL” marking is static information, and the “123456” is the human readable serial number. The bar-code 304 and the human readable serial number are variable information. The serial number could come from a subscriber or user of the present invention, or alternatively be assigned by the present invention's computer programming.

The present inventions programming and database will contain the serial number information, and can drive the printing of this tag information in a printing process. The printed tag 302 will also contain information on the grade 305 of the chain and components used in the alloy chain sling. The “GRADE” marking is static information, the number “80” indicates the particular grade of chain and components being used to makeup the alloy chain sling. The present invention's database will contain the grade 305 information and can drive the printing of this tag information in a printing process. The size 306 of the chain being used to makeup the alloy chain sling may also be included on the printed tag 302.

Additionally, the printed tag 302 may contain information on the reach 307 in feet and inches or whatever units desirable, of the alloy chain sling. The “REACH”, “FT”, and “IN” markings are static information. The numbers “12” and “6” indicate the particular reach of the alloy chain sling. The present invention's database will contain the reach 307 information and can drive the printing of this tag information in a printing process. Information in the present invention's database can drive the printing of a tag 302 as described above, but the information in the database can also be used to drive an inspection due date report for a particular customer. Further, the database information can be used to generate a form that has the inspection parameters and required measurements for a particular piece of material handling equipment. Reports of voluntary, or mandatory inspections can be made to various governmental, insurance, companies departments or individuals as desired. The reports are linked to the database as is commonly known in the art. The reports may contain a plurality of queries and thereby provide detailed information on the safety and status of lots of equipment. These reports may be transmitted electronically via e-mail or file transfer protocol, or alternatively printed on the printer 203 which is linked to the subscriber's computer 202 through a link 208. Link 208 may be hardwired or wireless. The printer 203, as shown in FIG. 2, is a local printer, but may be a printer on a network. The printer 203 may be used to print a downloaded report from the subscriber's computer 202.

The report may be a list of material handling equipment that is due for inspection, a report for a government agency, an industry safety department or an insurer. The report may also be a downloaded list from the subscriber's computer 202 which indicates what material handling equipment has been tagged “repair” or “scrap”. The printer 203 may also be used to print any pertinent material-handling equipment documents that are accessible through the subscriber's computer 202 through the links on the webpage in the browser 102. These documents may include relevant webpages, drawings, specifications, regulations, work instructions, etc. available, on-line or within the subscriber's network. Of course, the printer 203 may also be used to print any non-relevant documents that are accessible by the subscriber's computer 202.

A general description of the present invention as well as a preferred embodiment of the present invention as been set forth above. Those skilled in the art to which the present invention pertains will recognize and be able to practice additional variations in the methods and systems described which fall within the teachings of this invention. Accordingly, all such modifications and additions are deemed to be within the scope of the invention which is to be limited only by the claims appended hereto.

What is claimed is:

1. A method of maintaining equipment inspection records, the method comprising:
inputting equipment data on a remote computer;
transmitting the equipment data to a host computer;
storing the equipment data on the host computer;
selecting the equipment for inspection;
inspecting the selected equipment;
determining the inspection results; and
updating the equipment data with the inspection result.

2. The method of maintaining the equipment inspection records of claim 1 further comprising accessing the equipment data through a browser.

3. The method of maintaining the equipment inspection records of claim 1 wherein the equipment data is displayed on a webpage.

4. The method of maintaining the equipment inspection records of claim 1 wherein the host computer is a network server.

5. A method of reporting equipment safety information, the method comprising:
storing equipment information onto a host computer;
accessing the equipment information from a remote computer;
inspecting the equipment;
determining the inspection results;
storing the inspection results on the host computer;
accessing the inspection results; and
generating a report based upon the inspection results and equipment information.

6. The method of reporting equipment safety information of claim 5 wherein the remote computer is a laptop computer.

7. The method of reporting equipment safety information of claim 5 wherein the remote computer is a personal digital assistant.

8. The method of reporting equipment safety information of claim 5 wherein the remote computer is a pen-based computer.

9. The method of reporting equipment safety information of claim 6 wherein the method further comprises electronically transmitting the report to a desired recipient.

10. The method of reporting equipment safety information of claim 5 further comprising printing the report.

11. A system for maintaining inspection information on material handling equipment, the system comprising:
an identification tag including bar-coded information;
a bar-code scanner capable of reading the bar-coded information;
a remote computer operatively linked to the bar-code scanner;
a host computer operatively linked to the remote computer;
a database stored on the host computer, the database including the bar-coded information in non-bar-code format; and
an input device operatively connected to the remote computer for updating the database with inspection information.

12. The system for maintaining inspection information on material handling equipment of claim 11 wherein the input device is a keyboard.

13. The system for maintaining inspection information on material handling equipment of claim 11 further comprising a printer.

14. The system for maintaining inspection information on material handling equipment of claim 11 wherein the host computer is operatively linked to the remote computer via the Internet.

15. A system for reporting equipment inspection information, the system comprising:
means for inputting inspection information into a database on a host computer;
means for accessing the information on the database;
means for generating a report based on the information; and
means for transmitting the report to a third party.

16. A new identification tag for a sling, the identification tag comprising:
a section of durable material;
a printed tag affixed to the durable material;
the printed tag containing bar-coded information relating to the sling; and
an over laminate to protect the printed tag.

17. A method of identifying equipment for inspection, the method comprising:
labeling equipment with an identification tag including bar-coded information relating to the identity of the equipment;
scanning the bar-coded information; and
retrieving the identification of the equipment based ont eh scanned bar-coded information.
